(19) United States
(12) Patent Application Publication
(10) Pub. No.: US 2012/0011157 A1
(43) Pub. Date: Jan. 12, 2012

(54) Method and system for inferencing taxonomy topic concept objects using a metamodel instance model

(75) Inventor: Lionel Mauclaire, St. Parres Les Vaudes (FR)

(73) Assignee: Lindsey Technologies.com Inc., Aurora, CO (US)

(21) Appl. No.: 13/135,481

(22) Filed: Jul. 6, 2011

Related U.S. Application Data
(60) Provisional application No. 61/362,106, filed on Jul. 7, 2010.

(51) Int. Cl. G06F 17/30

(52) U.S. Cl. 707/777; 707/E17.055

(57) ABSTRACT

A method of creating a metamodel includes retrieving, from non-volatile storage of a computer system, a predetermined definition of multiple containers. The method includes retrieving, from the non-volatile storage, predetermined syntax rules specifying allowed dependency relationships between the containers. The method also includes selectively creating taxonomy topic concept objects in the containers. The method further includes selectively creating a dependency relationship between one of the taxonomy topic concept objects of a first one of the containers and one of the taxonomy topic concept objects of a second one of the containers, wherein the dependency relationship is only created when allowed by the predetermined syntax rules. The method also includes selectively creating additional dependency relationships as allowed by the predetermined syntax rules. The method further includes using the computer system, generating the metamodel based on the containers, the taxonomy topic concept objects, and the dependency relationship.

### CROSS-REFERENCE TO RELATED APPLICATIONS

This application claims the benefit of U.S. Provisional Application No. 61/362,106 filed on Jul. 7, 2010. The disclosure of the above application is incorporated herein by reference in its entirety.

### REFERENCE TO COMPACT DISC APPENDIX

The present disclosure incorporates by reference the computer program listings submitted on compact disc herewith.

### FIELD

The present disclosure relates to methods and systems for inferencing taxonomy topic concept objects using a specific metamodel instance model.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Inferencing via a specific metamodel instance model environment allows users to simulate complex scenarios with a high-level inferencing tool. Specific metamodel instance model environments provide the user with the basic tool with which the user can create a specific inferencing instance model. The user-defined conceptual relations, which may also be referred to as an inference instance model, can then be processed by an application, which can be used as a specific inferencing instance model. Often, inferencing environments provide a visual language, allowing users to create detailed models, without requiring low-level knowledge of the underlying classes that make up the model.

Existing specific metamodel instance model environments may be used to create domain-specific instance modeling with inferencing taxonomy topic concept objects. A domain is the particular area where an instance inferencing model can be used to solve problems or inferencing scenarios. For example, a specific metamodel instance model for instance inferencing may provide an environment for conveniently defining the entities, relationships between those entities, and the behavior of those entities and relationships that make up an instance inferencing model application. Thus, by defining the taxonomy topic concept objects, the user has created a domain-specific instance model. The inferencing environment can then create conceptual relations that can be used to create instance models that comply with the domain-specific instance application.

Specific metamodel instance model include syntax and semantics. The syntax defines the legal instance entities or components of a model, including their defined properties, as well as the legal relationships between those entities. The semantics specify the interpretation or behavior of the entities and relationships of the specific metamodel instance model. Put another way, the syntax is the basic building blocks and the rules for construction, while the semantics are the rules for interpretation. Specific metamodel instance model environments generally do not allow the user to define the syntax (e.g. properties, relationships, etc.) for a specific metamodel instance model. In general, the semantics of a specific metamodel instance model do not require some degree of programming. These data structures are standard and do not need to be learned by any user wishing to create conceptual relations using a specific metamodel instance model. The objective of a specific metamodel instance model is to allow end-users to create their own instance inferencing application. To this end, the semantics are defined in terms of the taxonomy topic concept objects being selected rather than being created, requiring the user to learn a new application programming interface (API).

### SUMMARY

The specific metamodel instance model, comprising syntax and semantics, is compiled or interpreted to create a specific instance model and supporting taxonomy topic concept objects inferencing. In turn, taxonomy topic concept objects can be used to create domain-specific instance models for an XML (Extensible Markup Language)—SKOS (Simple Knowledge Organization System)—XML vocabulary development application.

Fortunately, building a XML-SKOS-XML vocabulary development application with the use of a specific metamodel instance model for the need of inferencing taxonomy topic concept objects in an instance model does not require any changes and has the effect of producing an original instance application. Therefore, instance models based upon the specific metamodel instance model creating domain-specific model are valid instance applications, as they are tied to the structure of the specific metamodel instance model. Therefore, the user is not forced to recreate instance models whenever changes are made to the inferencing instance taxonomy topic concept objects.

Accordingly, a method and a specific metamodel instance model environment using taxonomy topic concept objects inferencing are disclosed herein. Taxonomy topic concept objects are sets of software interfaces and implementations of these interfaces that mirror the specific metamodel instance model and provide foundational semantic support to users (e.g., support for the creation of instance models). In addition, they can be used to create inferencing expressed in the domain model. Taxonomy topic concept objects may be available to the specific metamodel instance model to define the semantic structure of the inferencing. Instead of coding against a set of unfamiliar libraries, the semantics can be defined using the inferencing relations of the taxonomy topic concept objects themselves.

In one aspect, a method for creating an instance model is disclosed. The method comprises (a) creating the taxonomy topic concept objects, wherein the taxonomy topic concept objects comprise domain-specific entities, relationships between the entities, and a description of the domain semantics; (b) accessing taxonomy topic concept objects, wherein the taxonomy topic concept objects are generated as the application is created in the one of the three taxonomy module editor, and wherein the taxonomy topic concept objects correspond to the entities and capture their properties and relationships; and (c) creating the instance model using the taxonomy topic concept objects. The method may further comprise using the specific metamodel instance model and adding as necessary the corresponding taxonomy topic concept objects.

In another aspect, a method for providing taxonomy topic concept objects for use in an inferencing environment is disclosed. The method comprises (a) providing a framework for creating inferencing instances relations, wherein the specific metamodel instance model comprises three unique entity instances, relationships and domain semantics, and the framework accepts input from a user to add taxonomy topic concept objects to the entities and relationships; (b) dynamically generating the inferencing, wherein the taxonomy topic concept objects comprise source code for one or more classes, and wherein each class corresponds to one of the taxonomy topic concept objects instances; (c) supporting the specification of semantics using taxonomy topic concept objects; and (d) compiling the source code. Further, the method may comprise updating the taxonomy topic concept objects to reflect the change to the user specifications, wherein updating the ontology objects comprises generating new source code for one or more classes; updating user specified semantics that reference the changed taxonomy topic concept objects constructs, wherein updating the semantics comprises object references and method calls; and compiling the source code.

The specific metamodel instance model environment may include an interface for creating and modifying at least one instance model, wherein the specific metamodel instance model comprises three types of entities, one or more relationships between the entities, and domain semantics. The interface may accept user input to define the instances relationships of entities, the relationships between the entities, and the domain semantics. The specific metamodel instance model environment may also include program logic that is executable to dynamically maintain a plurality of taxonomy topic concept objects, wherein the taxonomy topic concept objects correspond to the defined taxonomy topic concept objects and the relationships i.e., the inferencing between the taxonomy topic concept objects. Further, the specific metamodel instance model environment may include an interface that calls methods on the taxonomy topic concept objects to create one or more instance models. In some implementations the interface may be a graphical user interface (GUI).

The taxonomy topic concept objects may comprise a plurality of object-oriented classes in a programming language such as Java. Each class may correspond to an entity from the application-defined specific metamodel instance model. Each entity may be defined as having a plurality of properties, and instance model data may capture the values of these properties for all instances. Taxonomy topic concept objects classes may include at least one method. The methods may be called to create, delete, and modify instance model data. In one implementation, the instance model data is comprised of instances of the taxonomy topic concept objects classes. In another implementation, the instance model data is comprised of data in a data structure. In yet another implementation, the instance model data is comprised of data in a XML file stored on disk.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram depicting a predetermined metamodel according to the principles of the present disclosure, including generic entities and conceptual relations;

FIG. 2 is a block diagram depicting an entity instance model derived from the predetermined metamodel, including instance relationships and cardinality constraints;

FIG. 3 is a block diagram depicting entity instance projects with corresponding taxonomy topic concept objects, instance relationships inferencing, and cardinality;

FIG. 4 is a block diagram depicting pseudo code of taxonomy topic concept objects use case scenario inferencing;

FIGS. 5-11 are block diagrams depicting example instance models including pseudo code of taxonomy topic concept objects use case scenario inferencing;

FIG. 12 is a functional block diagram depicting an example system;

FIG. 13 is a functional block diagram of an example implementation of a portion of the system of FIG. 12;

FIG. 14 is a flowchart illustrating an example method of operating a system according to the principles of the present disclosure; and

FIGS. 15A-15I are screen shots of an example user interface presented by the system of FIG. 13.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors or a group of execution engines. For example, multiple cores and/or multiple threads of a processor may be considered to be execution engines. In various implementations, execution engines may be grouped across a processor, across multiple processors, and across processors in multiple locations, such as multiple servers in a parallel processing arrangement. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are non-volatile memory, magnetic storage, and optical storage.

Dynamic taxonomy topic concept objects capture and maintain semantics that are consistent with the specifications of the application-defined specific metamodel instance. In practice, this may be accomplished by generating (and compiling, if necessary) program code for taxonomy topic concept objects whenever a user modifies an instance model. Accordingly, an exemplary specific metamodel instance environment provides tools for creating an instance model. The tools provided by the specific metamodel instance environment can be used to define an instance model that includes entity instances, properties of entity instances, relationships among those entity instances, and the behavior of those entity instances. In particular, the tool may create dynamic taxonomy topic concept objects including classes that correspond to the entities that make up the application-defined taxonomy. These classes may include constructors to create and initialize instance model instances of the specific metamodel instances entities and destructors to delete instances from the instance model and perform clean-up. They may also have methods that create, delete, and modify the instance model data that correspond to properties. Further, they may also capture the relationships between the application-defined entities. In particular, the classes may include further methods that create, delete, and modify the instance model data that captures the relationships between the entity instances.

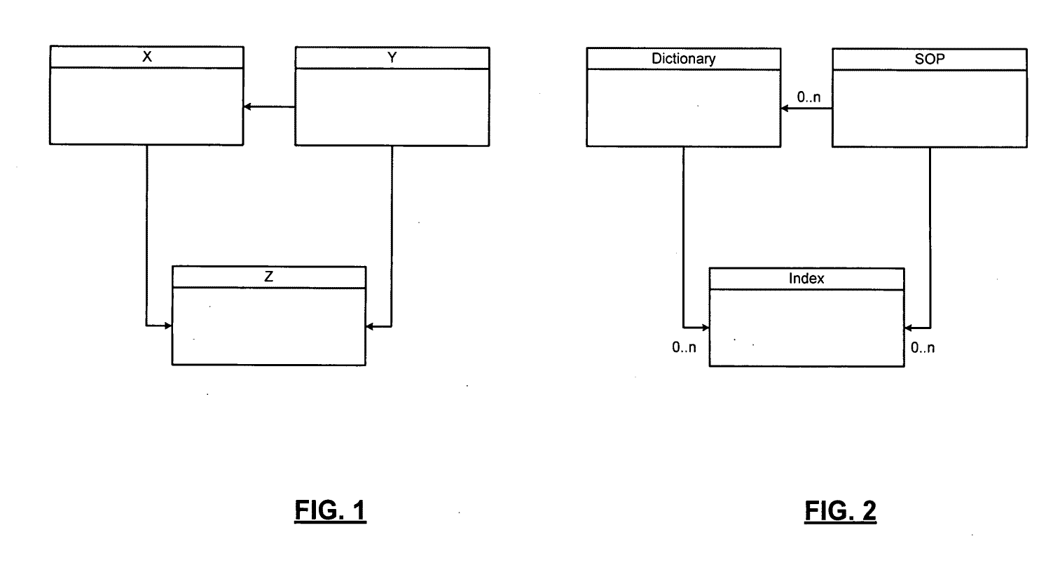

FIGS. 1-11 may be interpreted as UML (unified modeling language) diagrams. Referring now to FIG. 1, a predetermined metamodel instance entity instance relationship within an application editor is shown. The predetermined metamodel instance includes three defined generic entity instances: entity instance X, entity instance Y, and entity instance Z. All entity instances define one of the three taxonomy modules containers in the editor application and a cardinality relationship constraint. Each entity instance provides a list of taxonomy topic concept objects instances, to which the cardinality relationship constraint is applied when the taxonomy topic concept object is selected from its defined entity instance. The specific metamodel instance relationship is defined by an entity-instance rule scheme: entity instance X has a rule source relationship with target entity instance Z, and entity instance Y has a rule source relationship with target entity instances X and Z.

Relationships between the three entities in the application-defined specific metamodel instance are only of one type: (0:N) none to many. In the specific metamodel instance, relationships are defined to have a multiplicity, with a cardinality constraint. Cardinality constraints restrain the possible multirelation that an instance can assign to the relationship type. For each of the two entity types you can specify a pair of indices between parentheses and separated by a colon, as in (1:N). The left character may be 0 or 1, while the right character may be 1 or N. The specifiers assigned to a relationship provide restrictions on the cardinality (i.e., the number of elements) of certain relationships in an instance of the schema. More precisely: if the first character is 0, it imposes no bound; if the second character is N, then a multirelation instantiating the relationship type must be a relation, that is, it cannot happen that entities are related twice, it is a 0-to-many type of relationship (0:N). A 0-to-many relationship means that an instance of the first entity instance may be related in the defined manner to multiple instances of a second type of entity instance.

By selecting an instance model structure, a user defines the syntax of the instance model. A user defines the semantics by selecting the taxonomy topic concept objects of the instance model. FIG. 4 shows an example of semantics defined without creating taxonomy topic concept objects.

The instance model where taxonomy topic concept objects are generated dynamically in the application editor may be selected by the user as a whole and or item by item. The user calls the taxonomy topic concept objects from an entity module of the application editor by selecting and clicking on the menu project dependencies of the taxonomy topic concept object selected from the entity module of the application editor. As already defined, the application editor comprises three instance entity modules with their respective taxonomy topic concept objects. The specific metamodel structure mirrors the three entity modules structure in the application editor. That allows the user to create the inferencing relationships and behavior that make up the instance model.

As a user creates instance models, taxonomy topic concept objects selected and added to the instance model reflect the entity instances represented in the entity module of the application editor. More specifically, one or more instance entity may be generated for each user-selected entity module. Variables and methods on these instance entities are then generated that may (a) capture the relationships between instance entities objects and the taxonomy topic concept objects and (b) capture the foundational elements of the specific metamodel instance semantics that allow a user to create, access, and manipulate instances of the generated instances entities objects. Generation of the taxonomy topic concept objects occurs dynamically, so that this process is transparent to the user creating the instance model. Taxonomy topic concept objects may be generated on an entity-by-entity basis or in response to a predetermined event. For example, as each entity instance is created, a corresponding taxonomy topic concept object is created. These instance entities may be updated to include the appropriate method and variables as relationships are defined. Method and variables applied to relationships are solely based on the cardinality constraint of the specific metamodel instance.

As another example, taxonomy topic concept objects may be created in response to an indication that the user has completed the specification of the instance model. After taxonomy topic concept objects are generated, they may be used to extend the instance model further with inferencing conceptual relations or create and manage instance model data. While the depicted method refers to creating a single instance model, many instance models can be created using the taxonomy topic concept objects from the specific metamodel instance.

In one aspect, methods may be provided to the instance model for defining, accessing, and/or manipulating instance model data for two of the instance entities model as depicted above due to the defined relationship rule scheme. For example, when any of the taxonomy topic concept objects in the application editor are accessed by the taxonomy topic concept object, the user selects in the menu the project dependencies action. The taxonomy topic concept objects list is accessed and add and delete methods may allow a user to specify, delete, and/or add taxonomy topic concept objects to the list.

Referring to FIG. 1, a predetermined metamodel is depicted. The syntax of the defined specific metamodel includes three generic entities: X, Y, and Z. The semantics of the specific metamodel depict the defined conceptual relations between the three generic entities: X to Z, Y to X, and Y to Z.

FIG. 2 depicts the entity instance model as a block diagram defined in Unified Modelling Language. The syntax of the defined entity instance model includes three defined entities: Dictionary, Index, and semantic-oriented programming (SOP). The semantics of the instance model depict the defined instances conceptual relationships and their cardinality constraints between the instances of the three generic entities: Dictionary to Index, SOP to Dictionary and SOP to Index. Conceptual relationships between the instances of the three defined entities are only of one type: a 0-to-many relationship. It is an optional relationship, meaning that no instance or one instance of the first entity may be related in the defined manner to multiple instances of a second type of entity, 0 is the minimum cardinality of the first type of entity, and N is the maximum cardinality of the second type of entity, but each instance of the second type of entity may only be related with a single instance of the first type of entity. Optional relationships are typically indicated by the conditional tense. For example, an employee may be assigned to a project. The relationship is not mandatory as in a one-to-many entity relationship case.

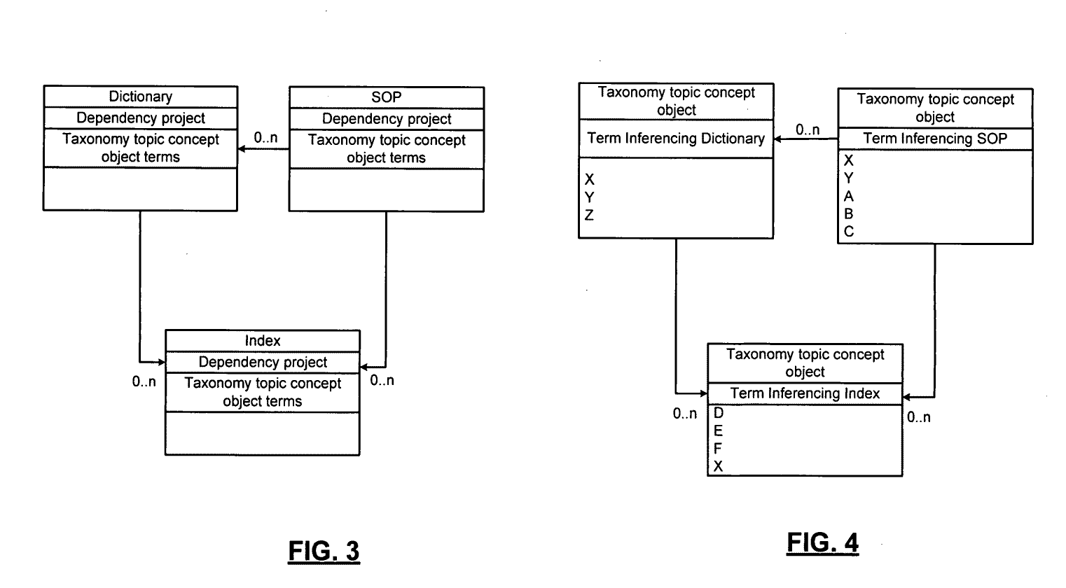

FIG. 3 depicts an instance module container model. The syntax of the defined instance module container model includes three module containers: Dictionary, SOP, Index, and their respective dependency project: the taxonomy topic concept objects. The semantics of the instance module container model depicts the defined instances relationships and their cardinality constraints between the taxonomy topic concept objects of the three module containers entities.

FIG. 4 shows an example user-defined instance model. The taxonomy topic concept objects have been selected to capture syntax and semantics of the inferencing instance model. Further, instance model inferencing has been created according to the user-defined instance model. This model captures the created inferencing relationship between taxonomy topic concept objects: Operation Indicators of the SOP defined module container, Sector Specific Indicators of the dictionary module container, and Financial Indicators of the index module container. This structure represents a model use case, where a created inferencing relationship of two single relations between taxonomy topic concept objects is represented in pseudo code that is implemented in the application editor.

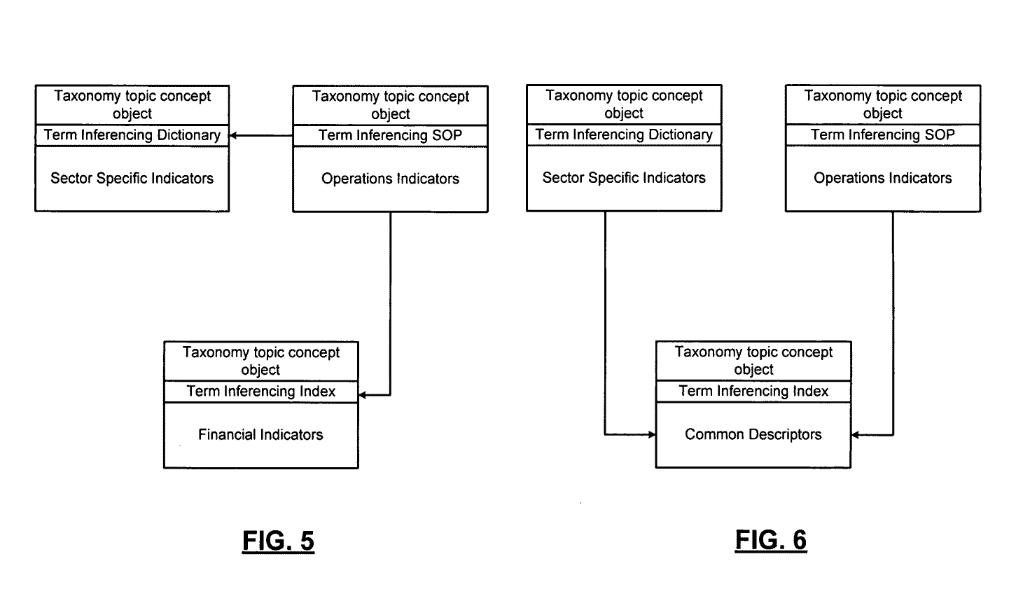

FIGS. 5-8 show example user-defined instance models. The taxonomy topic concept objects have been selected to capture syntax and semantics of the inferencing instance model. Further, instance model inferencing has been created according to the user-defined instance models. These models capture the created inferencing relationship between taxonomy topic concept objects Operation Indicators of the SOP defined module container, Sector Specific Indicators of the dictionary module container, and Financial Indicators of the index module container. These structures represent model use cases, where created inferencing relationships between taxonomy topic concept objects are represented in pseudo code that is implemented in the application editor.

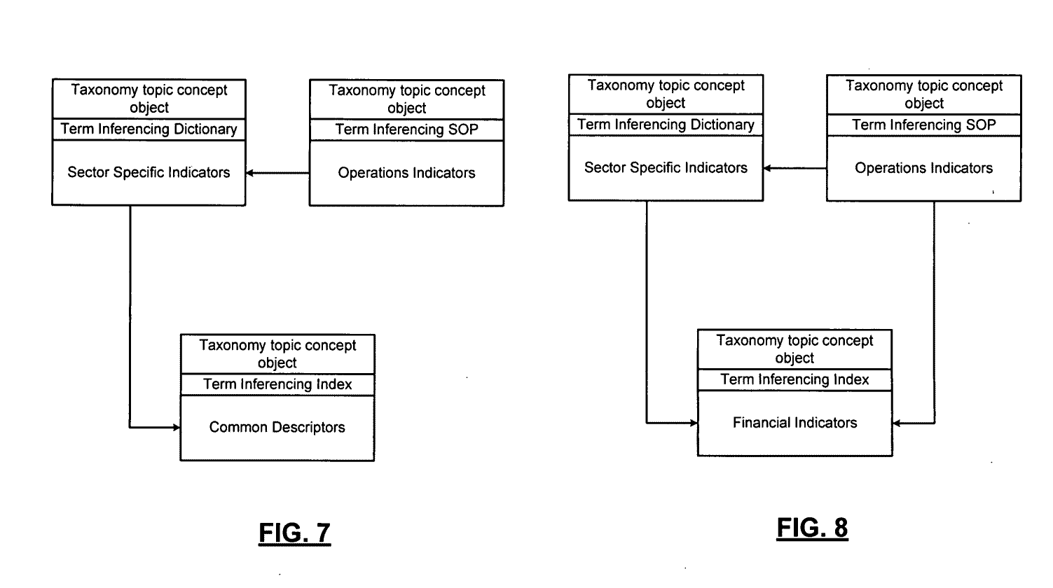

In FIG. 5, inferencing relationships are created from the term inferencing SOP to the term inferencing dictionary and from the term inferencing SOP to the term inferencing index. In FIG. 6, inferencing relationships are created from the term inferencing SOP to the term inferencing index and from the term inferencing SOP to the term inferencing index. In FIG. 7, inferencing relationships are created from the term inferencing SOP to the term inferencing dictionary and from the term inferencing dictionary to the term inferencing index. In FIG. 8, inferencing relationships are created from the term inferencing SOP to the term inferencing dictionary, from the term inferencing SOP to the term inferencing index, and from the term inferencing dictionary to the term inferencing index.

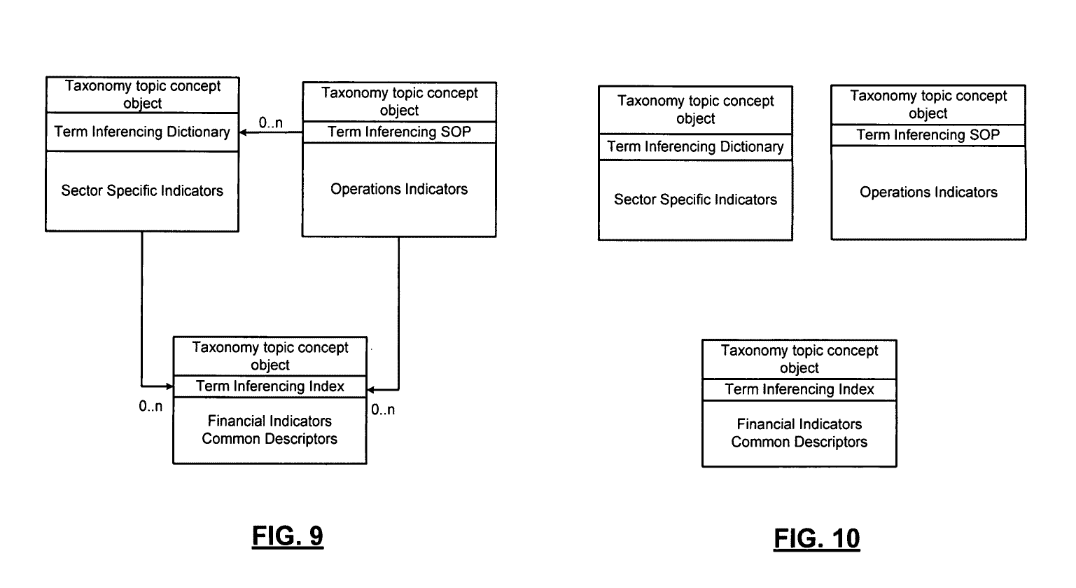

FIGS. 9-10 also show example user-defined instance models. These models capture created inferencing relationships between taxonomy topic concept objects Operation Indicators of the SOP module container, Sector Specific Indicators of the dictionary module container, and Financial Indicators and Common Descriptors of the index module container. In FIG. 9, inferencing relationships are created from the term inferencing SOP to the term inferencing dictionary, from the term inferencing SOP to the term inferencing index, and from the term inferencing dictionary to the term inferencing index. In FIG. 10, no relationships between taxonomy topic concept objects are represented in pseudo code that is implemented in the application editor.

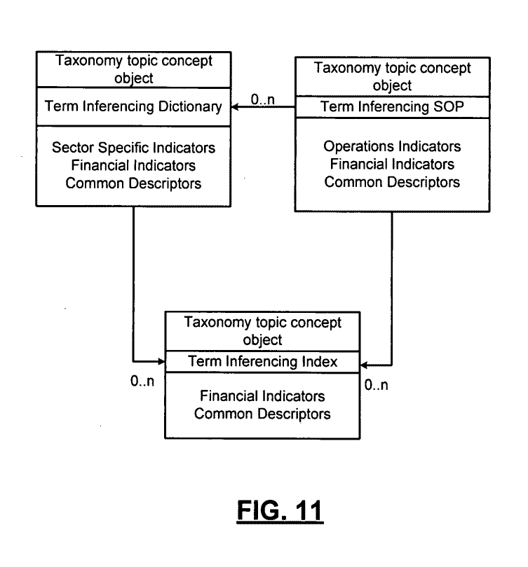

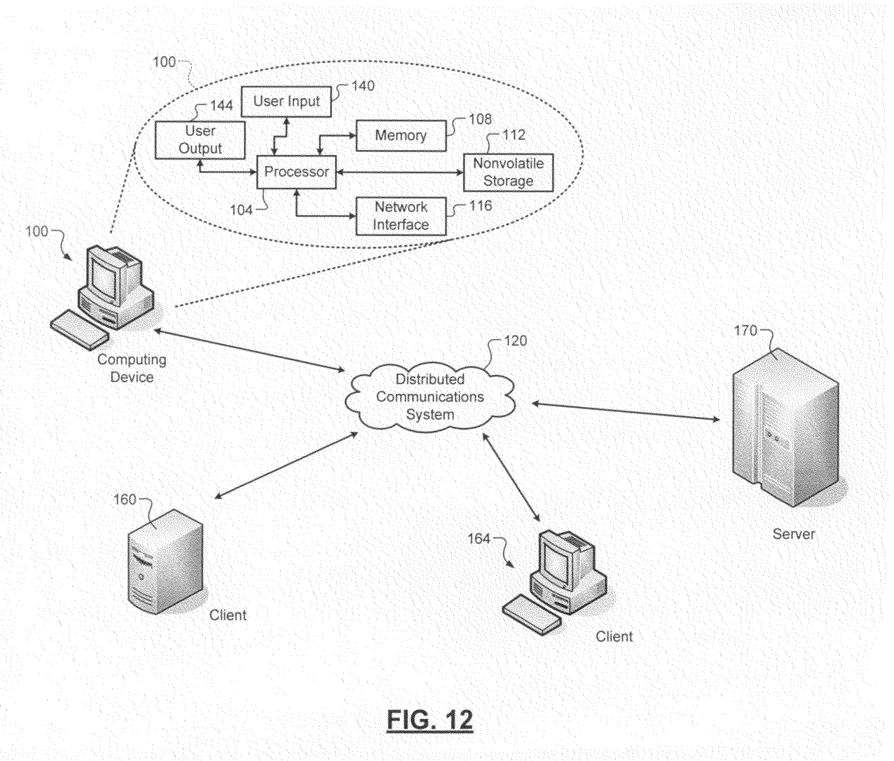

In FIG. 11, the model captures created inferencing relationships between taxonomy topic concept objects Common Descriptors, Operations Indicators, and Financial Indicators of the SOP module container, Sector Specific Indicators, Financial Indicators, and Common Descriptors of the dictionary module container, and Common Descriptors and Financial Indicators of the index module container. Inferencing with multiple relationships between taxonomy topic concept objects is created and is represented in pseudo code that is implemented in the application editor.

In FIG. 12, an example computing device 100 is shown. In various implementations, the computing device 100 includes a processor 104 that executes instructions from memory 108, which may include volatile and non-volatile memory. The processor 104 may retrieve information from non-volatile storage 112, such as a hard drive, a tape drive, or an optical drive. In various implementations, data may be transferred directly between the memory 108 and the non-volatile storage 112 using any suitable mechanism, such as direct memory access (DMA).

The processor 104 communicates with a network interface 116, which establishes connectivity with a distributed communications systems 120, such as the Internet. Various networking devices may be located between the computing device 100 and the distributing communications system 120, such as routers, switches, firewalls, proxies, and other components, such as components of an Internet service provider (ISP).

The processor 104 receives user input from a user input module 140. The user input module may include, for example only, a keyboard, a mouse, a pen tablet, a touch screen, a joystick, a foot pedal, and/or a microphone. The processor 104 may relay information to a user via a user output module 144. The user output module 144 may include a display device (which may be integrated with a touch screen), a printer, a speaker, etc.

Other devices may communicate with the computing device 100. For example, clients 160 and 164 may provide data to the computing device 100 and/or receive modelling information from the computing device 100. In addition, remote control of the computing device 100 may be provided to the client 160 and/or the client 164. Although the client 160 is shown without an input device or a display, the client 160 may be controlled remotely and/or may be connected to input and output devices.

A server 170 may host information for the computing device 100 and may provide modelling data to the clients 160 and 164. Any one or more of the client 160 and 164 and the server 170 may communicate with the computing device 100 through a virtual private network (VPN), a corporate WAN (Wide Area Network), a local area network (LAN). The VPN or the WAN may or may not traverse the distributed communications system 120.

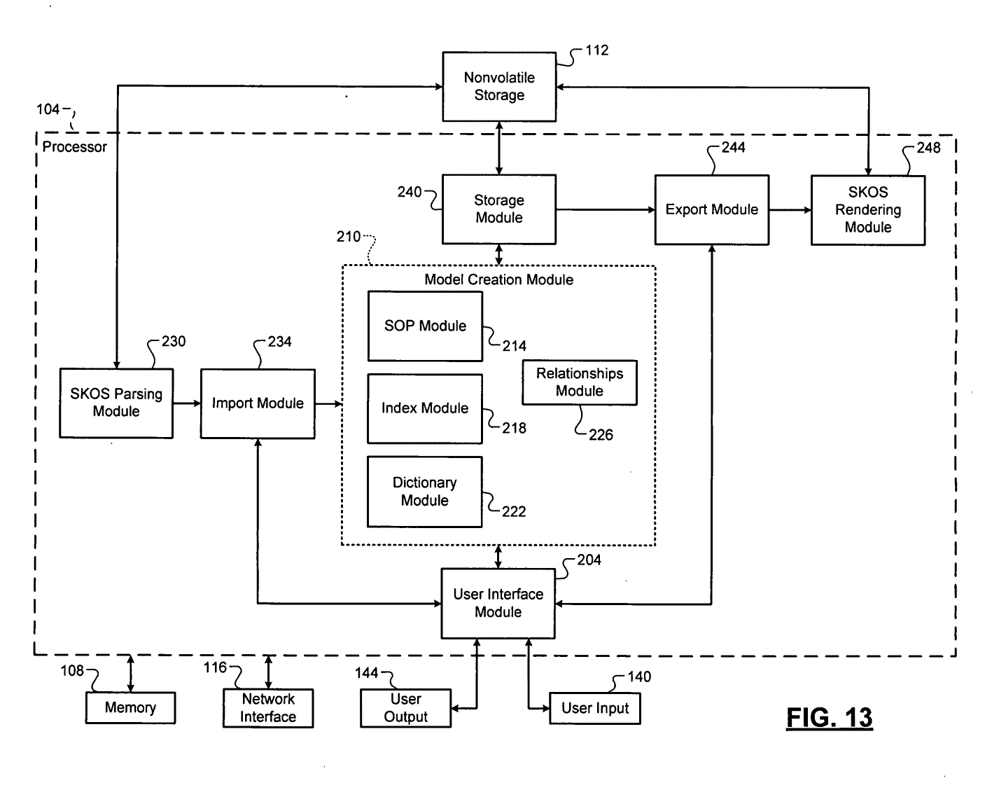

Referring now to FIG. 13, an example implementation is shown of a particular machine formed by the interrelationship of the processor 104 and instructions executed from the memory 108. A user interface module 204 presents a user interface to the user via the user output module 144. Users interact with the user interface by providing input to the user input module 140, which also interacts with the user interface module 204.

A model creation module 210 stores information relating to a metamodel and includes an SOP module 214, an index module 218, and a dictionary module 222. In addition, the model creation module 210 includes a relationships module 226 that stores information about the relationships defined between elements of the SOP module 214, the index module 218, and the dictionary module 222.

The user interface module 204 may allow the user to modify information and add data to the SOP index and dictionary, as well as define one or more relationships in the relationships module 226. The user interface module 204 may also provide the user with an option to import model information, such as from a model, ontology, or vocabulary. In various implementations, the model information may be in the form of SKOS (Simple Knowledge Organization System). A SKOS parsing module 230 may convert SKOS information stored by the non-volatile storage 112 into a format recognized by an import module 234. This intermediate format may then be stored on the non-volatile storage 112. The import module 234 processes the intermediate result and maps the data organization and hierarchies to the components of the model creation module 210.

The model creation module 210 provides the stored data, hierarchies, and relationships to a storage module 240, which provides the information to the non-volatile storage 112. The storage module 240 may use a format such as XML (Extensible Markup Language) or RDF (Resource Description Framework), which itself may be implemented using XML.

An export module 244 may be actuated based on user input by the user interface module 204. The export module 244 reads model data from the storage module 240 and provides that data to a SKOS rendering module 248. The information may be provided to the SKOS rendering module 248 in a predetermined form, such as XML. The SKOS rendering module 248 produces SKOS representations of the information provided by the export module 244, which may be stored in the non-volatile storage 112.

Once in the non-volatile storage 112, the SKOS models can be used by end-user applications, which may be located in the computing device 100 or may be located in another device, such as a clients 160 and 164, or the server 170. The SKOS representation may also be transmitted to one of the clients 160 or 164 and/or to the server 170. In various implementations, the SKOS representations are provided to the server 170, and then the clients 160 and 164 can query the SKOS information from the server 170.

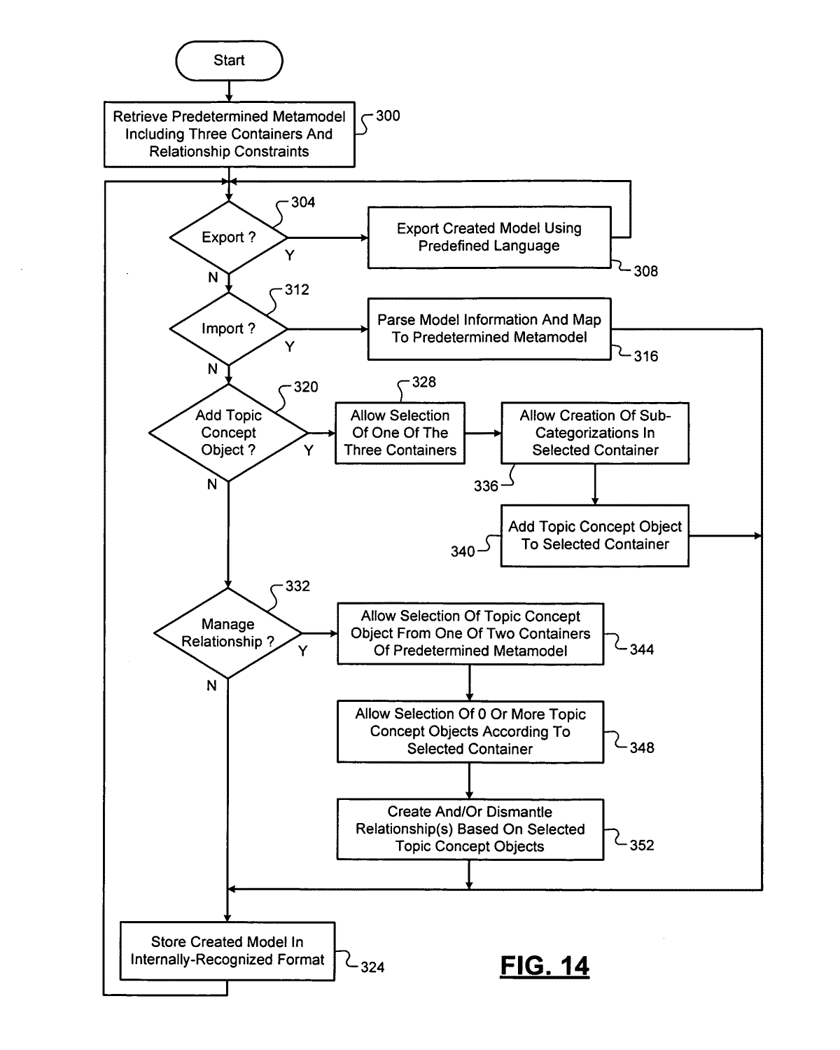

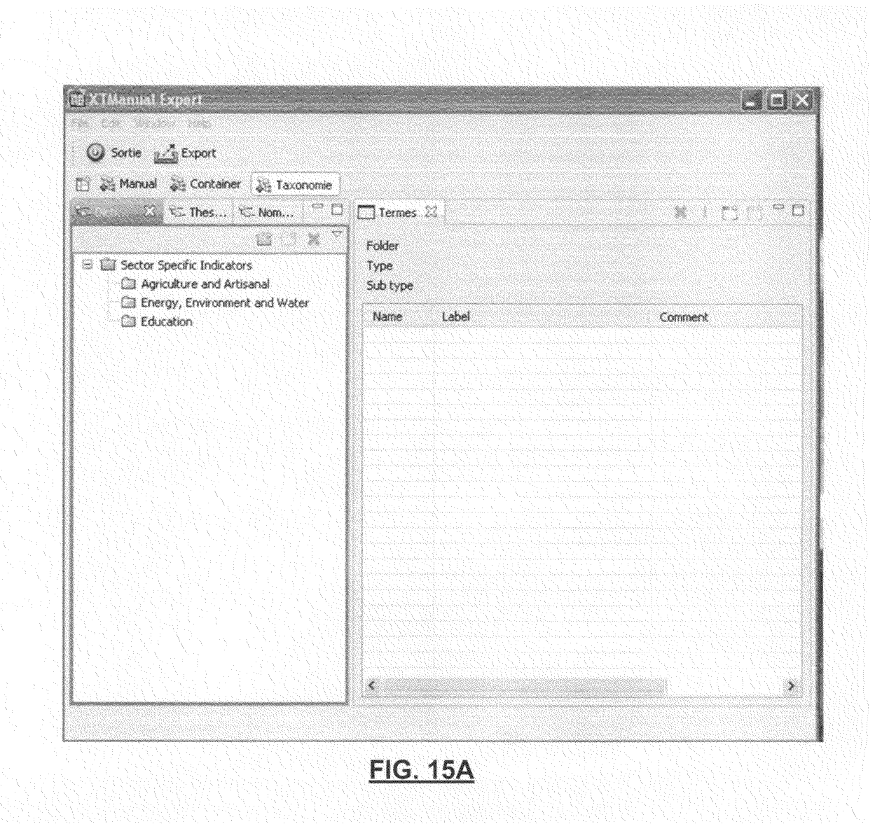

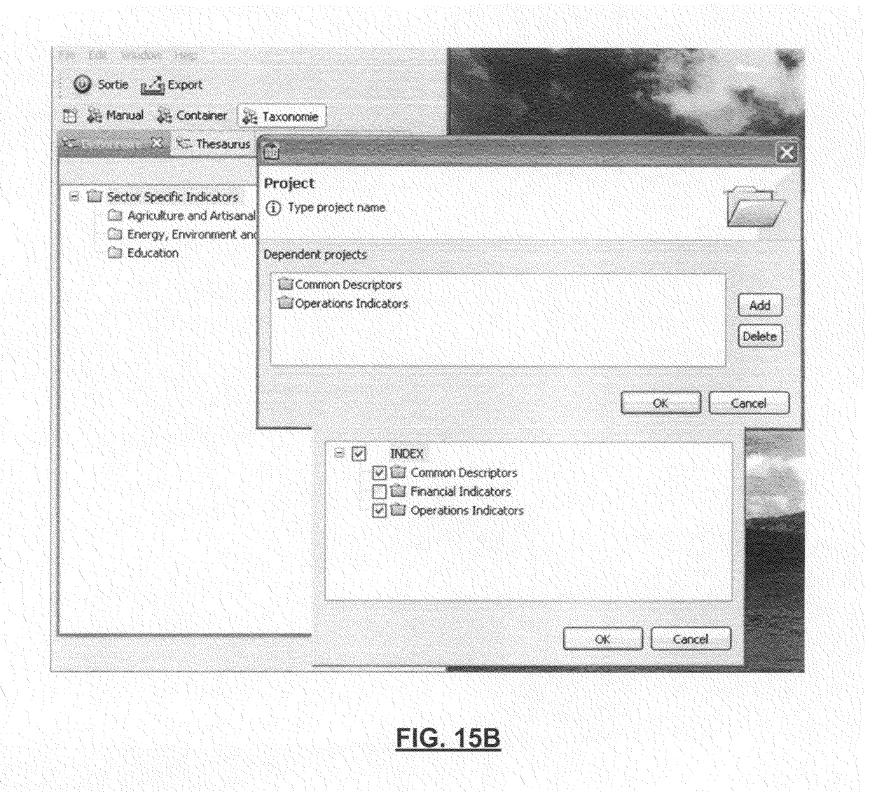

Referring now to FIG. 14, a flowchart depicts example operation of the particular machine shown in FIG. 13. In various implementations, control may start upon execution of a corresponding application. Control starts at 300, where a predetermined metamodel including three containers and relationship constraints among the three containers is retrieved. Control continues to 304 where control determines whether a user has requested an export. If so, control transfers to 308; otherwise, control transfers to 312. At 308, control exports the created model using a predefined language, such as SKOS. Control then returns to 304. At 312, control determines whether the user has requested an import. If so, control transfers to 316; otherwise, control transfers to 320. At 316, control parses the information specified by the user to be imported. The model information is mapped to the predetermined metamodel and associated data may be mapped to corresponding locations in the predetermined metamodel. Control continues at 324.

At 320, control determines whether the user has requested a topic concept object to be added. If so, control transfers to 328; otherwise, control transfers to 332. At 328, control allows for selection of one of the three containers into which the topic concept object is added. Control continues at 336, where control allows for creation of sub-categorizations in the selected container. The sub-categorizations may take the form of hierarchies and/or sub-folders. Control continues at 340, where the topic concept object is added to the selected container according to the specified sub-categorization. Control then continues at 324. Although not shown in FIG. 14, the user may also be provided the option of changing, renaming, and/or deleting topic concept objects and/or sub-categorizations.

At 332, control determines whether the user requests that a relationship be managed. If so, control transfers to 344; otherwise, control transfers to 324. At 344, control allows the selection of a topic concept object from one of two containers of the predetermined metamodel. When the three containers are a dictionary, an SOP, and an index, control may allow selection of the dictionary or the SOP for the root of the relationship, but not the index. As shown in, for example, FIG. 9, relationships from the SOP can be made to the dictionary or to the index, while the relationships from the dictionary can be made to the index. However, in various implementations, no relationships from the index to another container may be specified.

Control continues at 348, where control allows for the selection of zero or more topic concept objects to be selected according to the container selected at 344. As discussed above, a zero-to-many relationship may be created from a topic concept object of the SOP to a topic concept object of the dictionary or to a topic concept object of the index. Further, a zero-to-many relationship may be established from a topic concept object of the dictionary to a topic concept object of the index. Control continues at 352, where control creates and/or dismantles the relationship or relationships based on the topic concept objects selected by the user. Control continues at 324. At 324, control stores the created model in an internally-recognized format. Control may end once the application is terminated. However, ending of the application may be delayed until control has completed storing the created model at 324.

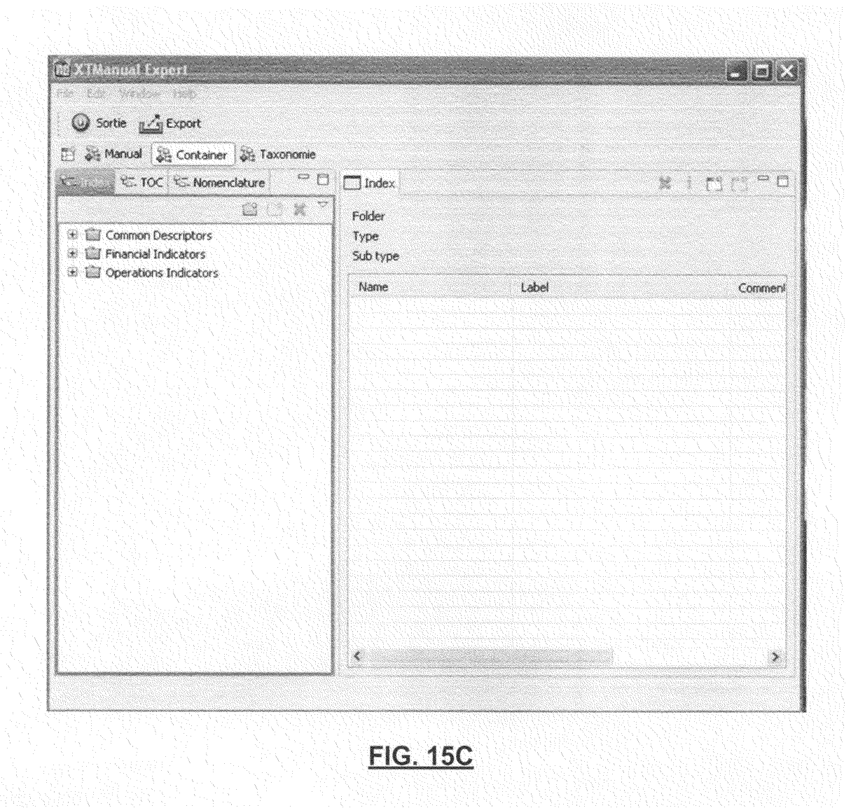

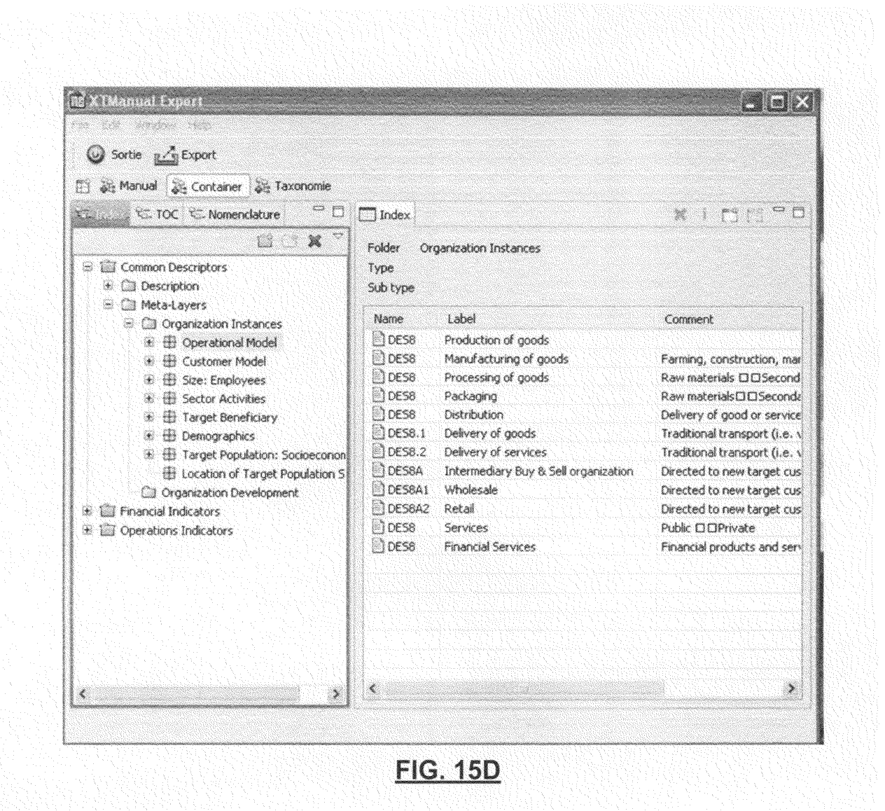

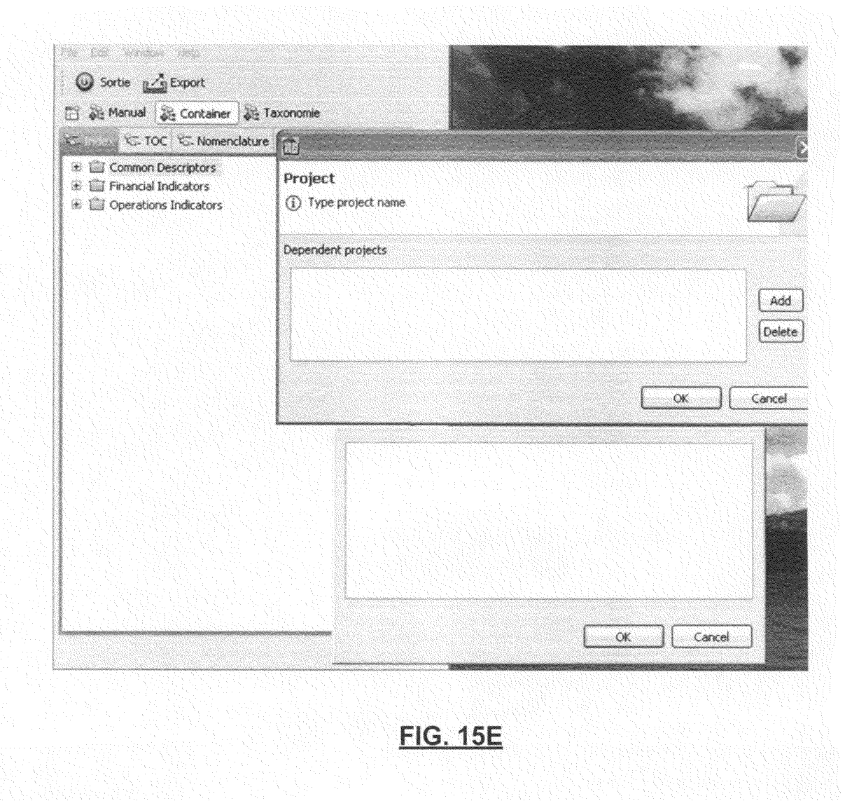

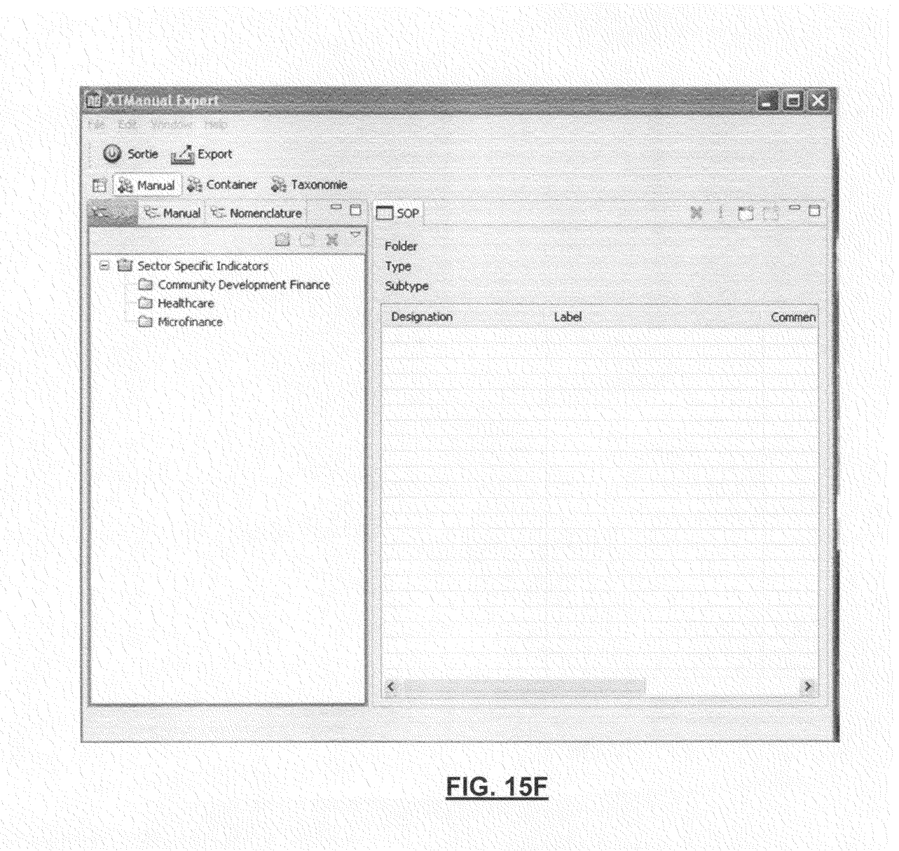

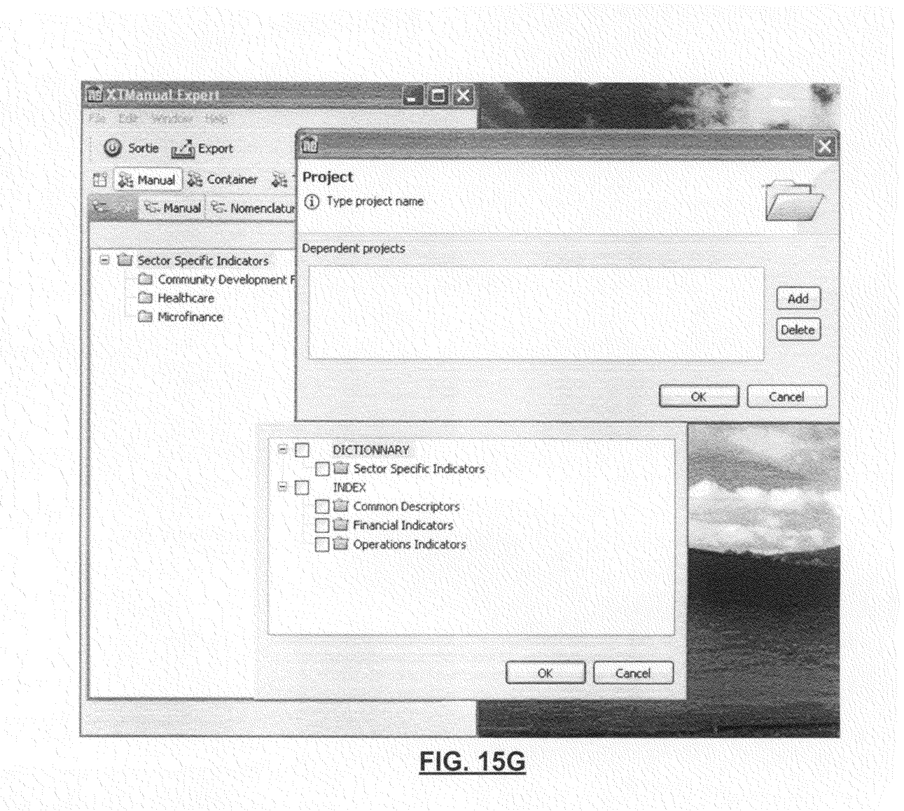

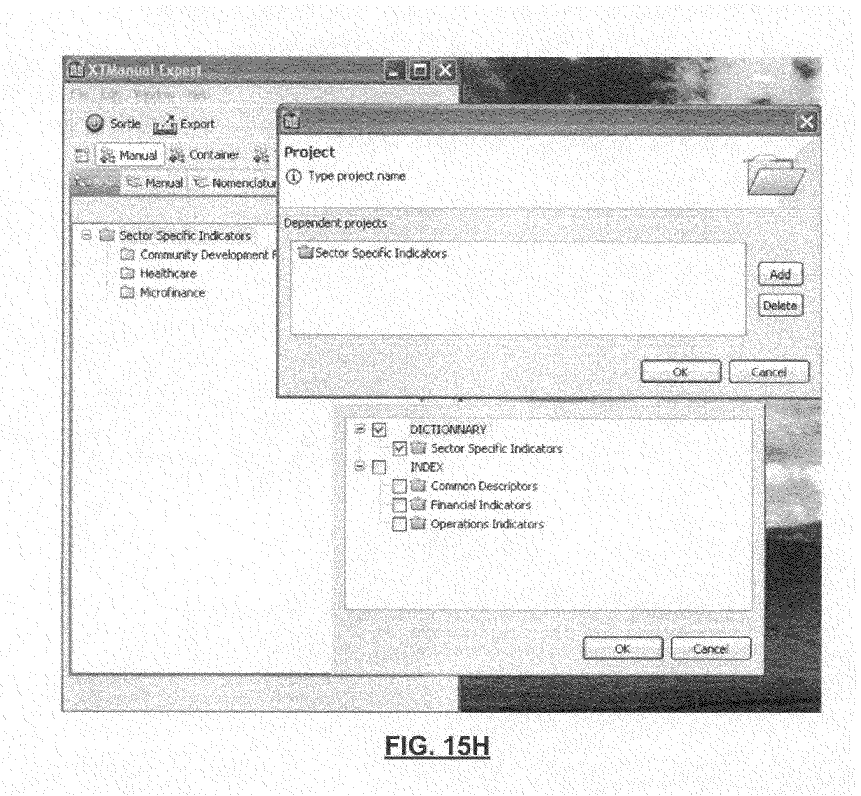

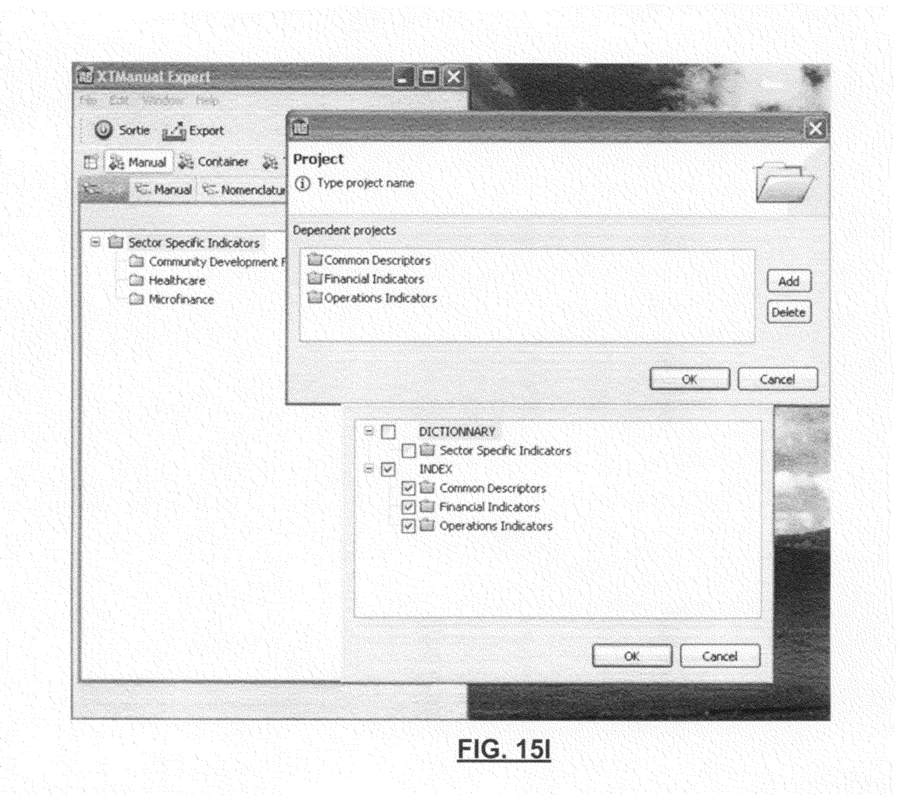

Referring now to FIGS. 15A-15I, screen shots of an example user interface presented by the system of FIG. 13, which may allow for operation of the flowchart of FIG. 14, are presented. In FIG. 15A, a view of the dictionary container is presented. The dictionary includes topic concept objects for purposes of illustration only. Under a project grouping of Sector Specific Indicators, sub-categorizations of “Agriculture and Artisanal”, “Energy, Environment and Water”, and “Education” are shown. In FIG. 15B, an example of dependency creation is shown. The currently dependent projects, Common Descriptors and Operations Indicators, are shown.

Once an ‘Add’ button is actuated, the projects within the index are shown. Recall from FIG. 2 that relationships from the dictionary to the index may be created. This is why projects from the SOP are not shown in FIG. 15B. Check marks in the dialog box next to the Common Descriptors and Operations Indicators specify that the Common Descriptors and Operations Indicators projects are dependent.

In FIG. 15C, the index container is shown. In FIG. 15D, an expansion of the Common Descriptors project is shown. A sub-categorization of a Description and a sub-categorization of Meta-Layers are provided for purposes of illustration only. Underneath Meta-Layers are further sub-categorizations of Organizational Instances and Organization Development. Listed beneath Organizational Instances are taxonomy topic concept objects Operational Model, Customer Model, etc. Objects of the Operational Model are listed in a right-hand pane—i.e., production of good, manufacturing of goods, etc. In FIG. 15E, dependency creation for the index is shown. As discussed above, and as shown in FIG. 2, relationships from the index to the dictionary or SOP are not permitted. Therefore, when the ‘Add’ button is actuated, the lower dialog box is shown empty, with no projects to which a dependency can be created.

In FIG. 15F, an example of the SOP container is presented. In FIG. 15G, a dependency creation for the SOP is presented. Again referring to FIG. 2, relationships are permitted from the SOP to the dictionary or to the index. For this reason, in FIG. 15G, projects from both the dictionary and index containers are displayed in the lower dialog box as possible dependent projects from the SOP. In FIG. 15H, the project Sector Specific Indicators from the dictionary container have been chosen as a dependent project, which is reflected in the upper dialog box. In FIG. 151, the dependency to the Sector Specific Indicators project of the dictionary container has been dismantled and dependency relationships have been created to the Common Descriptor, Financial Indicators, and Operations Indicators projects of the index container.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A method of creating a metamodel, the method comprising:
retrieving, from non-volatile storage of a computer system, a predetermined definition of a plurality of containers;
retrieving, from the non-volatile storage, predetermined syntax rules specifying allowed dependency relationships between the plurality of containers;
selectively creating taxonomy topic concept objects in the plurality of containers;
selectively creating a dependency relationship between one of the taxonomy topic concept objects of a first one of the plurality of containers and one of the taxonomy topic concept objects of a second one of the plurality of containers, wherein the dependency relationship is only created when allowed by the predetermined syntax rules;
selectively creating additional dependency relationships as allowed by the predetermined syntax rules; and
using the computer system, generating the metamodel based on the plurality of containers, the taxonomy topic concept objects, and the dependency relationship.

2. The method of claim 1 wherein the predetermined definition of the plurality of containers specifies three containers including a dictionary container, an index container, and a syntax-oriented programming (SOP) container.

3. The method of claim 2 wherein the predetermined syntax rules specify that dependency relationships are allowed from the SOP container to the dictionary container, from the SOP container to the index container, and from the dictionary container to the index container.

4. The method of claim 2 wherein the predetermined syntax rules specify that dependency relationships are only allowed from the SOP container to the dictionary container, from the SOP container to the index container, and from the dictionary container to the index container.

5. The method of claim 1 further comprising selectively creating sub-categorizations in a selected one of the plurality of containers, wherein each of the sub-categorizations includes ones of the taxonomy topic concept objects.

6. The method of claim 1 wherein the dependency relationship has a cardinality of zero-to-many from the one of the taxonomy topic concept objects of the first one of the plurality of containers to the one of the taxonomy topic concept objects of the second one of the plurality of containers.

7. A computer program product stored on a non-transitory computer-readable medium, the computer program product comprising instructions for:
retrieving, from non-volatile storage of a computer system, a predetermined definition of a plurality of containers;
retrieving, from the non-volatile storage, predetermined syntax rules specifying allowed dependency relationships between the plurality of containers;
selectively creating taxonomy topic concept objects in the plurality of containers;
selectively creating a dependency relationship between one of the taxonomy topic concept objects of a first one of the plurality of containers and one of the taxonomy topic concept objects of a second one of the plurality of containers, wherein the dependency relationship is only created when allowed by the predetermined syntax rules;
selectively creating additional dependency relationships as allowed by the predetermined syntax rules; and
using the computer system, generating a metamodel based on the plurality of containers, the taxonomy topic concept objects, and the dependency relationships.

8. The computer program product of claim 7 wherein the predetermined definition of the plurality of containers specifies three containers, including a dictionary container, an Index container, and a syntax-oriented programming (SOP) container, wherein the predetermined syntax rules specify that dependency relationships are allowed from the SOP container to the dictionary container, from the SOP container to the index container, and from the dictionary container to the index container.

9. The computer program product of claim 8 wherein the predetermined syntax rules specify that dependency relationships are only allowed from the SOP container to the dictionary container, from the SOP container to the index container, and from the dictionary container to the index container.

10. The computer program product of claim 7 further comprising selectively creating sub-categorizations in a selected one of the plurality of containers, wherein each of the sub-categorizations includes ones of the taxonomy topic concept objects.

11. The computer program product of claim 7 wherein the dependency relationship has a cardinality of zero-to-many from the one of the taxonomy topic concept objects of the first one of the plurality of containers to the one of the taxonomy topic concept objects of the second one of the plurality of containers.

12. A computer system comprising:
a storage module configured to store and retrieve a predetermined metamodel including a definition of a plurality of containers and syntax rules specifying allowed dependency relationships between the plurality of containers;
a model creation module including:
a syntax-oriented programming (SOP) module storing taxonomy topic concept objects related to an SOP container;
an index module storing taxonomy topic concept objects related to an index container;
a dictionary module storing taxonomy topic concept objects related to a dictionary container; and
a relationships module storing dependency relationships created between the SOP container, the index container, and the dictionary container; and
a user interface module that, in response to user input, selectively requests the relationships module to create a user-specified dependency relationship between a first taxonomy concept object of one of the SOP module, the index module, and the dictionary module and a second taxonomy concept object of one of the SOP module, the index module, and the dictionary module,
wherein the relationships module only creates the user-specified dependency relationship when the user-specified dependency relationship is allowed by the syntax rules.

13. The computer system of claim 12 further comprising:
an import module that provides data to the model creation module by parsing an input SKOS (Simple Knowledge Organization System) file; and
an export module that renders a model from the model creation module using SKOS.

14. The computer system of claim 12 wherein the syntax rules specify that dependency relationships are only allowed from the SOP container to the dictionary container, from the SOP container to the index container, and from the dictionary container to the index container.

15. The computer system of claim 12 wherein the user interface module, in response to user input, selectively requests the model creation module to add taxonomy topic concept objects to one of the SOP module, the index module, and the dictionary module.

16. The computer system of claim 12 wherein the storage module stores the predetermined metamodel using XML (Extensible Markup Language).

17. A method for operating a computer system to create an inferencing instance model, the method comprising:
in non-volatile storage of the computer system, storing a predetermined metamodel instance model, wherein the predetermined metamodel instance model comprises taxonomy topic concept objects, dependency relationships between the taxonomy topic concept objects, and a description of semantics;
creating inferencing for the taxonomy topic concept objects, wherein the taxonomy topic concept objects are selected as the inferencing is created; and
using the computer system, creating the inferencing instance model according to the dependency relationships.

18. A method for accessing a dependency instance framework of three predetermined taxonomy module containers, the method comprising:
storing, in a computer-readable medium, a predetermined metamodel instance model, wherein the predetermined metamodel instance model comprises the taxonomy module containers; predetermined dependency relationships between the taxonomy module containers, and a predetermined description of semantics for the taxonomy module containers;
accessing taxonomy topic concept objects inside each of the taxonomy module containers, wherein the taxonomy module containers are associated with the predetermined dependency relationships in the instance model; and using a computer system comprising the computer-readable medium, creating an
instance model using the predetermined metamodel instance model and the predetermined dependency relationships.

19. A method for creating an inferencing instance model with a predetermined metamodel instance model having predetermined cardinality features, the method comprising:
creating taxonomy topic concept objects in the predetermined metamodel instance model;
using a computer system, accessing and inferencing the taxonomy topic concept objects, wherein the taxonomy topic concept objects are selected as the inferencing is performed, and wherein the taxonomy topic objects have specific cardinality relationships based on the predetermined cardinality features; and
using the computer system, creating the inferencing instance model using (i) the predetermined metamodel instance model, (ii) the predetermined cardinality features, (iii) relationships based on the inferencing, and (iv) the taxonomy topic concept objects.

20. A method for creating an inferencing instance model, the method comprising:
using a computer system, defining a specific metamodel instance model, wherein the specific metamodel instance model comprises taxonomy topic concept objects, relationships inferencing between the taxonomy topic concept objects, and a description of semantics;
inferencing the taxonomy topic concept objects, wherein the taxonomy topic concept objects are located in designated taxonomy module containers and selected as the inferencing is performed, and wherein the taxonomy topic objects have dependency relationships;
creating the instance model using the dependency relationships; and
storing, using the computer system, the inferencing instance model according to at least one of XML-OWL (Extensible Markup Language—Ontology Web Language), XML-SKOS (XML - Simple Knowledge Organization System), XML-ORE (XML—Object Reuse and Exchange), and RDF/XML (Resource Description Framework/XML).
